(19) United States
(12) Patent Application Publication
(10) Pub. No.: US 2025/0128964 A1
(43) Pub. Date: Apr. 24, 2025

(54) FILTER ASSEMBLY

(71) Applicant: COWAY Co., Ltd., Gongju-si (KR)

(72) Inventors: Ju Hyuk EOM, Gongju-si (KR); Geun Sang RYU, Gongju-si (KR); Sung Kon CHO, Gongju-si (KR); Guk Won LEE, Gongju-si (KR); Sung Han YUN, Gongju-si (KR)

(73) Assignee: COWAY Co., Ltd., Gongju-si (KR)

(21) Appl. No.: 18/909,147

(22) Filed: Oct. 8, 2024

(30) Foreign Application Priority Data
Oct. 19, 2023 (KR) 10-2023-0140074

(51) Int. Cl. C02F 1/00

(52) U.S. Cl. CPC C02F 1/003; C02F 2201/007; C02F 2307/10

(57) ABSTRACT

A filter assembly is disclosed. A filter assembly according to an aspect of the present invention may include a first housing that is fluidly connected to the outside to receive raw water and transmit generated purified water to the outside; a second housing that is screw-coupled to the filter accommodation housing and fluidly connected to the outside; and a filter structure partially accommodated in each of the filter accommodation housing and the second housing, and configured to filter the raw water to generate the purified water, wherein the second housing includes a filter support body having a height in one direction and in which a filter support space is formed to at least partially accommodate the filter structure; and a handle member coupling rib protruding radially from the outer circumference of the filter support body.

### CROSS-REFERENCE TO RELATED APPLICATION

This application claims priority to and the benefit of Korean Patent Application No. 10-2023-0140074, filed on Oct. 19, 2023, the disclosure of which is incorporated herein by reference in its entirety.

### TECHNICAL FIELD

The present invention relates to a filter assembly, and more particularly, to a filter assembly having an improved structure for ease of assembly and disassembly.

### BACKGROUND OF THE INVENTION

A water purifier refers to an apparatus capable of filtering raw water to generate purified water and providing the generated purified water. As living standards have recently improved, water purifiers are increasingly provided and used not only in commercial facilities but also in general homes.

A traditional type of water purifier filters raw water that has already been delivered from an external water source to a demand area just before it is discharged. In the above case, the water purifier is generally configured to filter the tap water and provide it to the user when it is discharged for drinking purposes.

However, there may be cases in which raw water delivered from an external water source to a demand area is not suitable for drinking as well as for use as living water. For example, if the raw water provided from an external water source contains excessive foreign substances or the like, it is difficult to use it for shower purposes if the raw water is discharged as it is.

Accordingly, interest in water purifiers for first filtering and providing raw water delivered to the demand area is increasing recently. This type of water purifier, referred to as POE (Point-Of-Entry), primarily filters raw water delivered from an external water source and supplies it to homes or the like. Therefore, since the user may be provided with filtered purified water at least once, hygiene and user satisfaction may be improved.

In the case of the POE-type water purifier as described above, it is generally used in areas where the contamination of raw water or the content of foreign substances is relatively high. Therefore, foreign substances or the like generated in the process of filtering raw water easily contaminate the filter provided in the water purifier. Accordingly, the maintenance of the filter is more important for POE-type water purifiers than water purifiers provided for drinking purposes.

Meanwhile, since the POE-type water purifier does not directly provide filtered purified water to the user, it may be provided to be simplified including only a filter and components accommodating the filter. In this case, the components for accommodating the filter and the components connecting the external water source or demand area are airtightly combined with each other to prevent arbitrary leakage of raw water or purified water.

Moreover, in order to withstand the high water pressure of the water pipe, the above components are firmly combined with each other, making it difficult to perform the task of maintaining the filter easily. Accordingly, the work for maintaining the filter is performed only by the operator, and there is a limitation that it is difficult for the user to perform immediately in response to the state of the filter.

Furthermore, components accommodating the filter are generally formed in a cylindrical shape. Even if the components accommodating the filter are barely separated, there is also a concern that if the components fall, they will be unintentionally rolled due to their shape.

Korean Patent Registration No. 10-2279332 discloses a water filter assembly and a water purifier including the same. Specifically, it discloses a water filter assembly and a water purifier including the same that can easily replace the filter housing itself, including a filter housing that accommodates the filter and a housing cover that constitutes the lower side of the filter housing.

However, the water filter assembly and the water purifier including the same disclosed in the prior art document presuppose the exchange of the filter housing itself. The related art document does not provide a method for easily separating and exchanging filters accommodated in the filter housing.

Korean Patent Registration No. 10-2416530 discloses a housing apparatus for a filter for water purifier and a water purifier including the same. Specifically, it discloses a filter housing apparatus for a water purifier and a water purifier including the same that can construct a housing apparatus that accommodates a filter inside in the form of a tumbler, and combine and separate the body part and lid part that make up the housing apparatus by a fixing belt.

However, the filter housing apparatus for water purifier and a water purifier including the same, as disclosed in the prior art document, must have a separate component, that is, a fixing belt, so that the body part and lid part can be easily combined and separated. The related art document does not provide a method for easily combining and separating the body part and the lid part without an additional component.

Furthermore, the related art documents above do not provide a way to prevent situations in which the filter housing, which is generally formed in a cylindrical shape, is arbitrarily rolled.

### RELATED ART DOCUMENT

### Patent Document

Korean Patent Registration No. 10-2279332 (2021, Jul. 20)
Korean Patent Registration No. 10-2416530 (2022, Jul. 1)

### SUMMARY OF THE INVENTION

### Technical Problem

The present invention is to solve the above problems, and the present invention is directed to providing a filter assembly having a structure that is easy to maintain.

The present invention is also directed to providing a filter assembly having a structure capable of reducing the size of an external force applied during initial separation.

The present invention is also directed to providing a filter assembly having a structure in which an external force for separation can be easily applied.

The present invention is also directed to providing a filter assembly having a structure capable of preventing components from spinning with no traction due to an applied external force.

The present invention is also directed to providing a filter assembly having a structure capable of improving filtration efficiency.

The present invention is also directed to providing a filter assembly having a structure capable of filtering raw water in various ways.

The problems of the present invention are not limited to those mentioned above, and other problems not mentioned will be clearly understood by those of ordinary skill in the art from the following description.

### Technical Solution

According to an aspect of the present invention, provided is a filter assembly, including a filter accommodation housing that is fluidly connected to the outside to receive raw water and transmit generated purified water to the outside; a filter support housing that is screw-coupled to the filter accommodation housing and fluidly connected to the outside; and a filter structure partially accommodated in each of the filter accommodation housing and the filter support housing, and configured to filter the raw water to generate the purified water, wherein the filter support housing includes a filter support body having a height in one direction and in which a filter support space is formed to at least partially accommodate the filter structure; and a handle member coupling rib protruding radially from the outer circumference of the filter support body.

In this case, a filter assembly may be provided in which the filter assembly includes a handle member detachably coupled to the filter support housing and rotated together with the filter support housing by an external force, and when the handle member is rotated by a preset angle, the close coupling state between the filter accommodation housing and the filter support housing is released.

In addition, a filter assembly may be provided in which one part of the handle member surrounds the outer circumference of the filter support body, and another part of the handle member surrounds the handle member coupling rib.

In this case, a filter assembly may be provided in which the handle member coupling rib is formed to have a height in the one direction, a width in the radial direction, and a thickness in the outer circumferential direction of the filter support body.

In addition, a filter assembly may be provided in which the handle member includes a gripping extension extending in the radial direction of the filter support housing; and a filter housing coupling part that is continuous with the gripping extension and surrounds the filter support body in the radial direction.

In this case, a filter assembly may be provided in which the filter housing coupling part includes a filter housing accommodation space formed through therein to accommodate the filter support body; and a rib accommodation groove that is formed to be recessed in the inner circumference surrounding the filter housing accommodation space to accommodate the handle member coupling rib.

In addition, a filter assembly may be provided in which the handle member coupling ribs are provided as a plurality of groups, and the plurality of groups of handle member coupling ribs are disposed to be spaced apart from each other at a predetermined angle along the outer circumference of the filter support body, and the rib accommodation grooves are provided as a plurality of groups, and the plurality of rib accommodation grooves are disposed to be spaced apart from each other at the predetermined angle along the inner circumference of the filter housing coupling part.

In this case, a filter assembly may be provided in which a plurality of said handle member coupling ribs disposed to be spaced apart from each other along the outer circumference of the filter support body constitute the group.

In addition, a filter assembly may be provided in which the filter assembly includes a filter support base positioned on one side in the height direction of the filter support body and formed to have a smaller cross-sectional area than the filter support body, and the handle member coupling rib extends between the other end in the height direction of the filter support body and the lower end of the filter support base.

In this case, a filter assembly may be provided in which among each end of the handle member coupling rib, a width of one end positioned adjacent to the other end in the height direction of the filter support body is formed to be shorter than a width of the other end positioned adjacent to the lower end of the filter support base.

In addition, a filter assembly may be provided in which the filter assembly includes a filter accommodation body having a height in one direction and in which a filter accommodation space is formed to at least partially accommodate the filter structure; a filter accommodation base positioned on one side in the height direction of the filter accommodation body and detachably coupled to the filter support housing; and an anti-rolling rib protruding radially from the outer circumference of the filter accommodation body.

In this case, a filter assembly may be provided in which the anti-rolling rib is formed to have a height in the one direction, a thickness in the radial direction, and a width in the outer circumferential direction of the filter accommodation body.

In addition, a filter assembly may be provided in which a plurality of said anti-rolling ribs are provided, and the plurality of anti-rolling ribs are to be spaced apart from each other along the outer circumference of the filter accommodation body at a predetermined angle.

In this case, a filter assembly may be provided in which the filter support housing includes a filter support body having a height in one direction and in which a filter support space is formed to at least partially accommodate the filter structure; and a filter support plate positioned on one side in the height direction of the filter support body and formed to protrude further in the radial direction than the filter support body, and the filter accommodation housing includes a filter accommodation base that constitutes one side in the height direction and is accommodated in the filter support body; and a filter accommodation plate that constitutes the other side in the height direction of the filter accommodation base, is seated on the filter support plate, and protrudes further in the radial direction than the filter accommodation base.

In addition, a filter assembly may be provided in which the filter support plate includes a filter support identification protrusion formed to protrude radially from the outer circumference thereof, and the filter accommodation plate includes a filter accommodation identification protrusion formed to protrude radially from the outer circumference thereof.

In this case, a filter assembly may be provided in which the filter structure includes a filter frame extending in one direction and communicating radially with the internal spaces of the filter accommodation housing and the filter support housing, respectively; a filter member accommodated inside the filter frame and configured to filter the raw water flowing in the radial direction to generate the purified water; and a filter hollow formed through the filter member in the one direction to constitute an outlet flow path of the purified water.

In addition, a filter assembly may be provided in which the filter structure includes an additional filter member inserted into the filter hollow, and configured to filter again the purified water filtered while passing through the filter member.

### Advantageous Effects

According to the above configuration, maintenance of the filter assembly according to an exemplary embodiment of the present invention can be facilitated.

In addition, according to the above configuration, the filter assembly according to an exemplary embodiment of the present invention can reduce the size of the external force applied during the initial separation.

In addition, according to the above configuration, in the filter assembly according to an exemplary embodiment of the present invention, an external force for separation can be easily applied.

In addition, according to the above configuration, the filter assembly according to an exemplary embodiment of the present invention can prevent components from spinning with no traction due to an applied external force.

In addition, according to the above configuration, the filter assembly according to an exemplary embodiment of the present invention can improve filtration efficiency.

In addition, according to the above configuration, the filter assembly according to an exemplary embodiment of the present invention can filter raw water in various ways.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a perspective view illustrating a filter assembly according to an exemplary embodiment of the present invention.

FIG. 2 is an exploded perspective view illustrating the configuration of the filter assembly of FIG. 1.

FIG. 3 is a perspective view illustrating a filter connection member coupled to the filter assembly of FIG. 1.

FIG. 4 is a bottom view illustrating the filter connection member of FIG. 3.

FIG. 5 is a perspective view illustrating the filter assembly of FIG. 1.

FIG. 6 is a front view illustrating the filter assembly of FIG. 1.

FIG. 7 is a side view illustrating the filter assembly of FIG. 1.

FIG. 8 is an exploded perspective view illustrating the filter assembly of FIG. 1.

FIG. 9 is a perspective view illustrating a filter accommodation housing provided in the filter assembly of FIG. 1.

FIG. 10 is a bottom view illustrating the filter accommodation housing of FIG. 9.

FIG. 11 is a B-B cross-sectional view illustrating the filter accommodation housing of FIG. 9.

FIG. 12 is a perspective view illustrating a filter structure provided in the filter assembly of FIG. 1.

FIG. 13 is a plan view illustrating the filter structure of FIG. 12.

FIG. 14 is a C-C cross-sectional view illustrating the filter structure of FIG. 12.

FIG. 15 is a C-C cross-sectional view illustrating a modified example of the filter structure of FIG. 12.

FIG. 16 is a perspective view illustrating a filter support housing provided in the filter assembly of FIG. 1.

FIG. 17 is a plan view illustrating the filter support housing of FIG. 16.

FIG. 18 is a D-D cross-sectional view illustrating the filter support housing of FIG. 16.

FIG. 19 is an A-A cross-sectional view illustrating the filter assembly of FIG. 1.

FIG. 20 is a plan view illustrating the filter assembly of FIG. 1.

FIG. 21 is a bottom view illustrating the filter assembly of FIG. 1.

FIG. 22 is a perspective view illustrating a handle member coupled to the filter assembly of FIG. 1.

FIG. 23 is a plan view illustrating the handle member of FIG. 22.

FIGS. 24 to 26 are usage state views illustrating a separation process of a filter assembly and a filter connection member according to an exemplary embodiment of the present invention.

### DETAILED DESCRIPTION OF THE EMBODIMENTS

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

In the following description, in order to clarify the features of the present invention, descriptions of some components may be omitted.

The term “communication” used in the following description means that one or more members are connected to each other so as to be in fluid communication. In an embodiment, the communication may be formed by a member such as a conduit, a pipe, a tubing, or the like. In the following description, communication may be used in the same sense as one or more members are being “fluidly connected” to each other.

The term “fluid” used in the following description refers to any form of material that flows by external force and whose shape or volume can be changed. In an embodiment, the fluid may be a liquid such as water or a gas such as air.

The terms “above or upper side”, “below or lower side”, “left side”, “right side”, “front side”, and “rear side” used in the following description will be understood with reference to the coordinate system shown throughout the accompanying drawings.

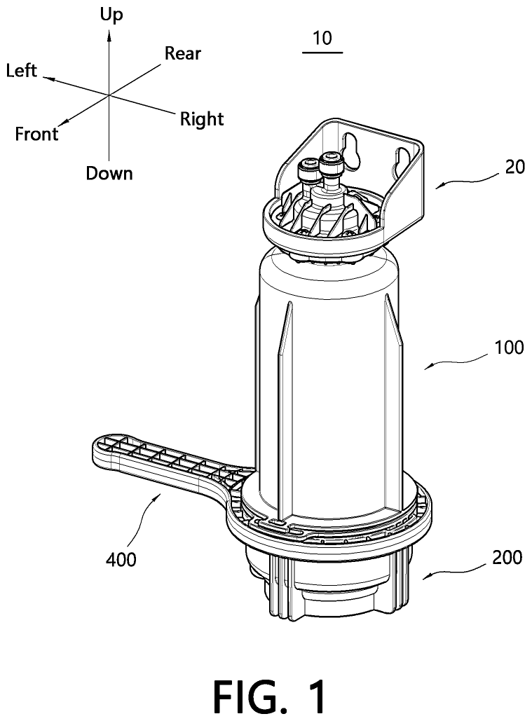

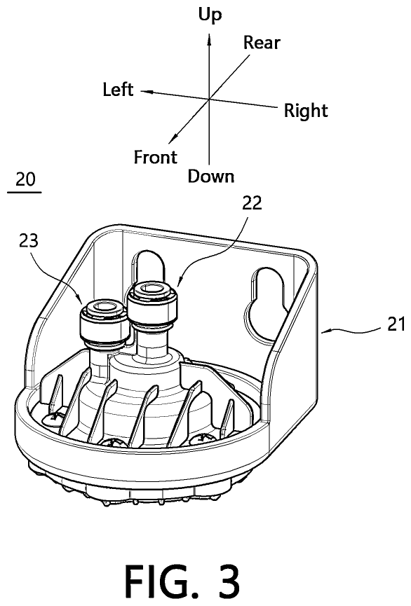

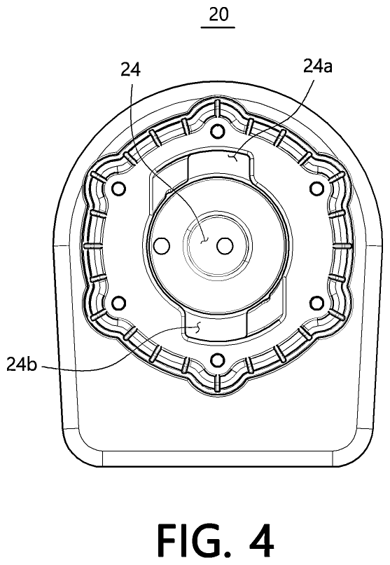

Referring to FIGS. 1 to 4, a filter assembly 10 and a filter connection member 20 to which the filter assembly 10 is coupled according to an exemplary embodiment of the present invention are illustrated. The filter assembly 10 is detachably coupled to the filter connection member 20. The filter assembly 10 is fluidly connected to an external water source (not shown) and an external demand area (not shown) by the filter connection member 20, respectively.

The filter connection member 20 may be coupled to an external structure (not shown). In an embodiment, the filter connection member 20 may be coupled to an inner wall of a storage cabinet of a sink or the like.

The filter connection member 20 is fluidly connected to an external water source (not shown) and an external demand area (not shown). In addition, the filter connection member 20 is fluidly connected to the detachably coupled filter assembly 10.

To this end, in the illustrated embodiment, the filter connection member 20 includes a bracket 21, an inlet fitting 22, an outlet fitting 23, and a filter coupling part 24.

The bracket 21 is a portion in which the filter connection member 20 is coupled to an external structure (not shown). The bracket 21 supports other components of the filter connection member 20. The bracket 21 may include a plurality of surfaces extending at a predetermined angle each other.

A through hole may be formed in any one of the plurality of surfaces, that is, the rear side surface in the illustrated embodiment, so that a fastening member (not shown) for coupling the bracket 21 to an external structure (not shown) may be coupled. Another one of the plurality of surfaces, that is, the lower surface in the illustrated embodiment, supports the inlet fitting 22, the outlet fitting 23, and the filter coupling part 24.

The inlet fitting 22 fluidly connects an external water source (not shown) to the filter assembly 10. The inlet fitting 22 is fluidly connected to an external water source (not shown), and a raw water inlet part 122 of the filter assembly 10, respectively.

The outlet fitting 23 fluidly connects an external demand area (not shown) to the filter assembly 10. The outlet fitting 23 is fluidly connected to an external demand area (not shown), and a purified water outlet part 121 of the filter assembly 10, respectively.

The filter coupling part 24 is a portion to which the filter assembly 10 is detachably coupled. The filter coupling part 24 is supported by said another surface of the bracket 21. The filter coupling part 24 is disposed to face the inlet fitting 22 and the outlet fitting 23 with said another surface of the bracket 21 interposed therebetween.

The filter coupling part 24 may be provided in a form in which the filter assembly 10 may be detachably coupled. In the illustrated embodiment, the filter coupling part 24 is formed as a space communicating with the inlet fitting 22 and the outlet fitting 23, respectively.

In the illustrated embodiment, the filter coupling part 24 includes a first opening 24a and a second opening 24b.

The first opening 24a and the second opening 24b accommodate a coupling protrusion 123 provided in the filter assembly 10. The first opening 24a and the second opening 24b communicate with other parts of the filter coupling part 24.

The filter assembly 10 may be rotated while the coupling protrusion 123 is accommodated in the first and second openings 24a and 24b to be coupled to the filter connection member 20. In addition, the filter assembly 10 coupled to the filter connection member 20 may be separated from the filter connection member 20 after the coupling protrusion 123 is rotated to be located in the first and second openings 24a and 24b. This will be described later in detail.

In this case, the filter connection member 20 may be provided together with the filter assembly 10 or may be provided separately. In the following description, it will be described on the premise that the filter connection member 20 is provided separately from the filter assembly 10 and is detachably coupled to the filter assembly 10.

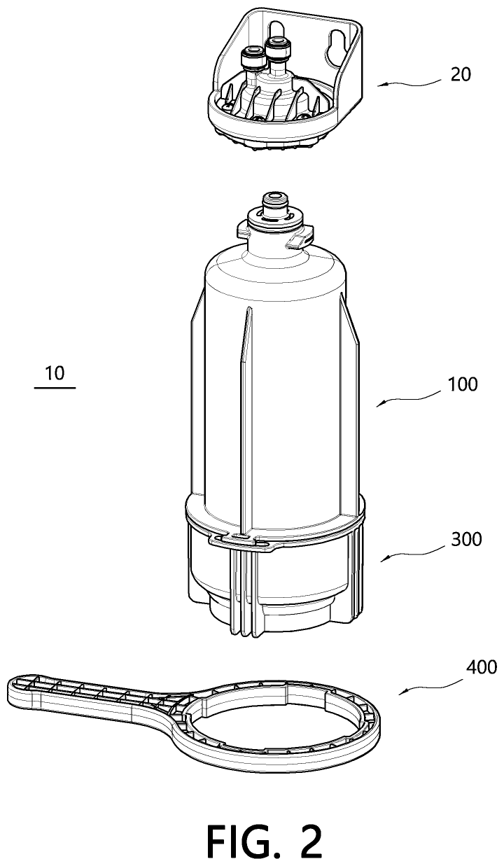

Referring back to FIGS. 1 to 2, a filter assembly 10 according to an exemplary embodiment of the present invention is shown. The filter assembly 10 may be detachably coupled to the filter connection member 20 to be fluidly connected to an external water source (not shown) and an external demand area (not shown), respectively.

Hereinafter, it is assumed that the filter assembly 10 according to an exemplary embodiment of the present invention is used in a POE-type water purifier. Alternatively, it will be understood that the filter assembly 10 may also be applied to a general water purifier, that is, a water purifier in the form of finally filtering the introduced raw water and providing it to the user.

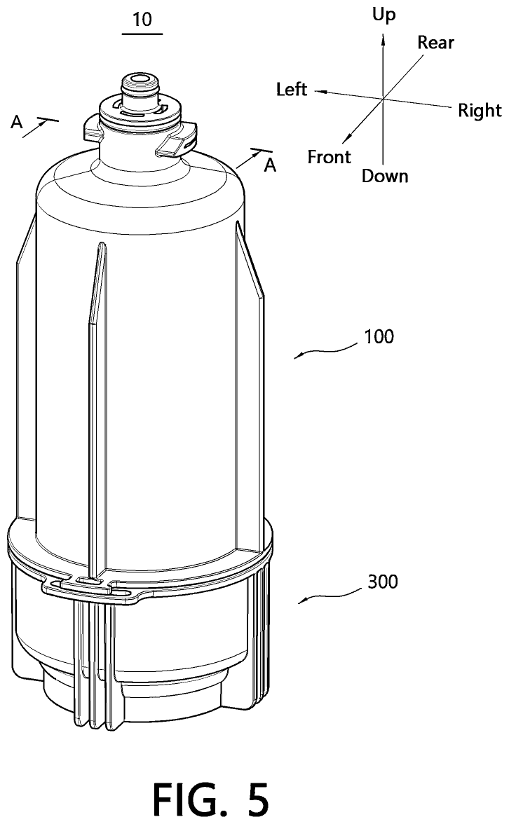

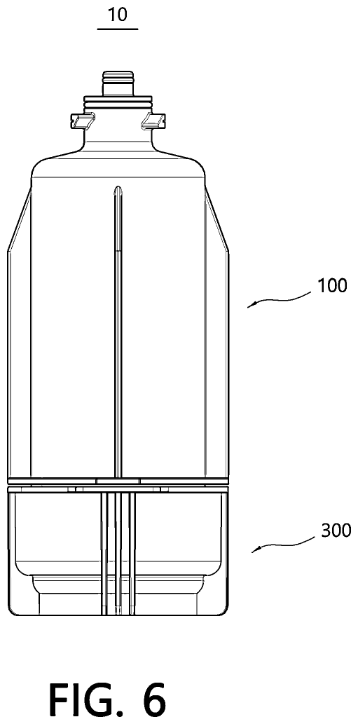

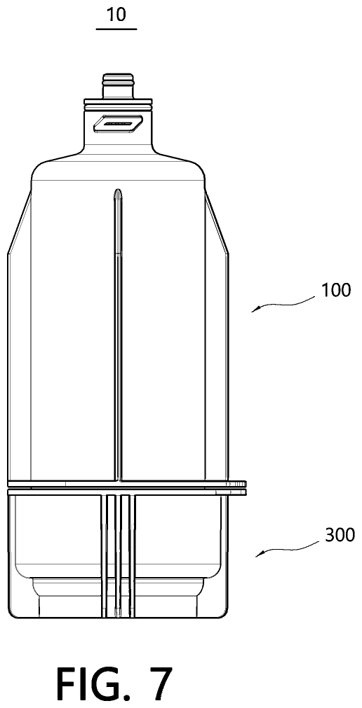

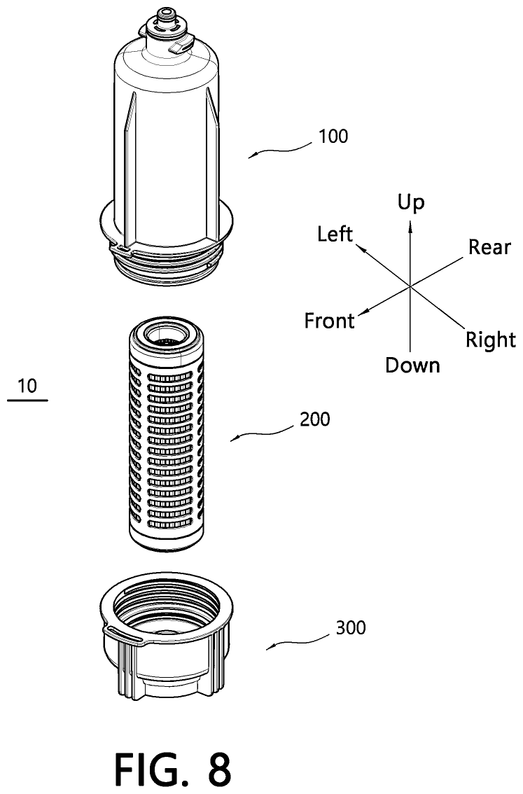

In the embodiments illustrated in FIGS. 5 to 8, the filter assembly 10 includes a filter accommodation housing 100, a filter structure 200, a filter support housing 300, and a handle member 400. In this case, the handle member 400 may be provided together with the filter assembly 10 or may be provided separately from other components of the filter assembly 10.

That is, the filter assembly 10 must include the filter accommodation housing 100, the filter structure 200, and the filter support housing 300, but may selectively include the handle member 400. Hereinafter, for convenience of explanation, it will be described on the premise that the handle member 400 is provided together as a component of the filter assembly 10.

The filter accommodation housing 100 is a portion to which the filter assembly 10 is detachably coupled to the filter connection member 20. A space fluidly connected to the filter connection member 20 is formed inside the filter accommodation housing 100.

The filter structure 200 is accommodated in the space of the filter accommodation housing 100. The filter accommodation housing 100 surrounds the accommodated filter structure 200 so that it is not arbitrarily exposed to the outside.

The filter accommodation housing 100 is coupled to the filter support housing 300. In this case, the filter accommodation housing 100 may be detachably coupled to the filter support housing 300. In the illustrated embodiment, the filter accommodation housing 100 is located above the filter support housing 300.

The space formed inside the filter accommodation housing 100 communicates with the space accommodated inside the filter support housing 300. The filter structure 200 may be at least partially accommodated in the filter accommodation housing 100 and the filter support housing 300, respectively.

In this case, the filter accommodation housing 100 may be firmly coupled to the filter support housing 300. In other words, the filter accommodation housing 100 may be coupled to the filter support housing 300 so as not to be separated by a rotational force applied by bare hands.

Accordingly, the handle member 400 may be provided to separate the filter accommodation housing 100 and the filter support housing 300. This will be described later in detail.

The filter accommodation housing 100 may have any shape that can be detachably coupled to the filter connection member 20 to be fluidly connected to the filter connection member 20, accommodate the filter structure 200, and be detachably coupled to the filter support housing 300. In the illustrated embodiment, the filter accommodation housing 100 has a cylindrical shape having a circular cross-section and having a height in the up-down direction.

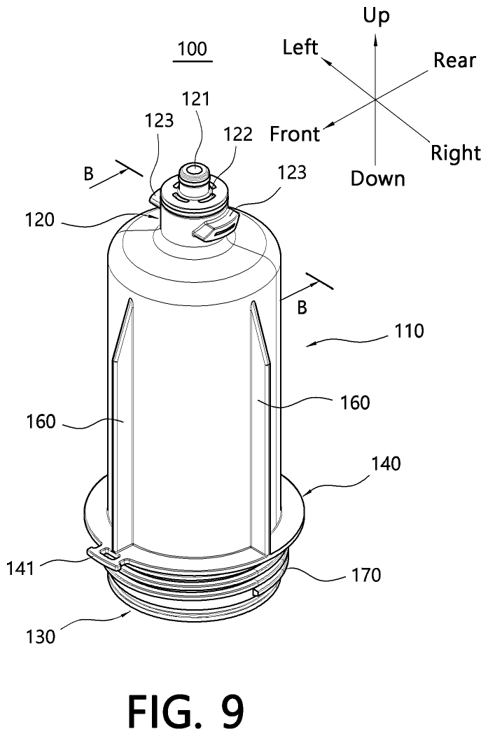

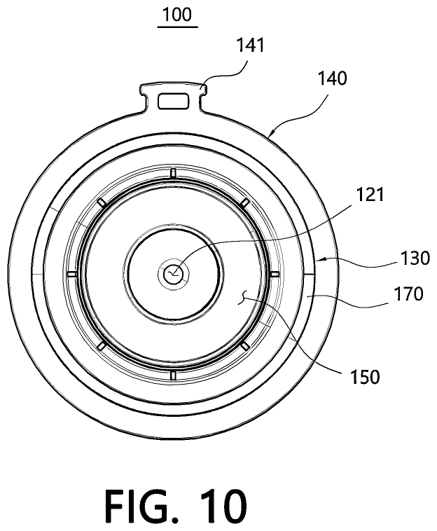

In the embodiments shown in FIGS. 9 to 11, the filter accommodation housing 100 includes a filter accommodation body 110, a filter connection member coupling part 120, a filter accommodation base 130, a filter accommodation plate 140, a filter accommodation space 150, an anti-rolling rib 160, and a filter accommodation thread 170.

The filter accommodation body 110 constitutes a part of the outer shape of the filter accommodation housing 100. The filter accommodation body 110 is coupled to other components of the filter accommodation housing 100 to support them. In addition, the filter accommodation space 150 is formed inside the filter accommodation body 110, so that the filter structure 200 may be surrounded by the filter accommodation body 110.

The filter accommodation body 110 may have a shape corresponding to the shape of the filter accommodation housing 100. In the illustrated embodiment, the filter accommodation body 110 has a cylindrical shape having a circular cross-section and having a height in the up-down direction.

One side in the height direction of the filter accommodation body 110, that is, the upper end in the illustrated embodiment, is closed, but a through hole is formed therein to be fluidly connected to the filter connection member coupling part 120.

The other side in the height direction of the filter accommodation body 110, that is, the lower end in the illustrated embodiment, is open to communicate with the filter support space 340 formed inside the filter support housing 300. The filter accommodation base 130 to which the filter accommodation housing 100 is coupled to the filter support housing 300 is positioned on the other side in the height direction of the filter accommodation body 110.

The filter accommodation body 110 is continuous with the filter accommodation plate 140. The filter accommodation plate 140 may extend in the radial direction from the outer circumference of the filter accommodation body 110.

The filter accommodation space 150 is formed inside the filter accommodation body 110. The inner circumference of the filter accommodation body 110 may define the filter accommodation space 150 by at least partially surrounding the filter accommodation space 150.

The anti-rolling rib 160 is formed on the outer circumference of the filter accommodation body 110. The anti-rolling rib 160 protrudes radially outward of the filter accommodation body 110 and extends in the height direction of the filter accommodation body 110.

The filter connection member coupling part 120 is a part in which the filter accommodation housing 100 is coupled to the filter connection member 20 to be fluidly connected. The filter connection member coupling part 120 is detachably coupled to the filter connection member 20. In addition, the filter connection member coupling part 120 is fluidly connected to the inlet fitting 22 and the outlet fitting 23, respectively.

The filter connection member coupling part 120 is coupled to the filter accommodation body 110. The filter connection member coupling part 120 is located on the one side in the height direction of the filter accommodation body 110, that is, on the upper side in the illustrated embodiment. A space fluidly connected to the inlet fitting 22 and the outlet fitting 23 is formed inside the filter connection member coupling part 120. The space communicates with the filter accommodation space 150 formed inside the filter accommodation body 110.

The filter connection member coupling part 120 may have any shape capable of being coupled to the filter accommodation body 110 to communicate with the filter accommodation space 150 and detachably coupled to the filter connection member 20. In the illustrated embodiment, the filter connection member coupling part 120 is formed to protrude upward from the one side in the height direction of the filter accommodation body 110.

In the illustrated embodiment, the filter connection member coupling part 120 includes a purified water outlet part 121, a raw water inlet part 122, and a coupling protrusion 123.

The purified water outlet part 121 is a space in which the filter connection member coupling part 120 is fluidly connected to the outlet fitting 23. The purified water outlet part 121 is formed through the inside of the filter connection member coupling part 120. The purified water outlet part 121 extends in the height direction of the filter connection member coupling part 120, that is, in the up-down direction in the illustrated embodiment.

One side of the purified water outlet part 121 in the extension direction, that is, the upper side in the illustrated embodiment, is open to communicate with the outlet fitting 23. The other side of the purified water outlet part 121 in the extension direction, that is, the lower side in the illustrated embodiment, is open to communicate with the filter accommodation space 150.

The purified water outlet part 121 is positioned to be spaced apart from the raw water inlet part 122. The purified water outlet part 121 is located radially outward of the raw water inlet part 122. A plurality of purified water outlet parts 121 may be provided. The plurality of purified water outlet parts 121 may be disposed to be spaced apart from each other in the inner circumferential direction of the filter connection member coupling part 120, and may be disposed to surround the raw water inlet part 122 from the radially outer side.

The positional relationship between the purified water outlet part 121 and the raw water inlet part 122 may be changed according to the structure of the filter structure 200. In other words, in the filter assembly 10 according to an exemplary embodiment of the present invention, since raw water passes through the filter structure 200 in a direction toward the radially inner side and is generated as purified water, the purified water outlet part 121 is located radially inside the raw water inlet part 122.

The purified water outlet part 121 may have any shape capable of communicating the outlet fitting 23 and the filter accommodation space 150. In the illustrated embodiment, the purified water outlet part 121 is formed as a three-dimensional figure shape space having an arc shape cross-section and having a height in the up-down direction.

The raw water inlet part 122 is formed radially outside the purified water outlet part 121.

The raw water inlet part 122 is a space in which the filter connection member coupling part 120 is fluidly connected to the inlet fitting 22. The raw water inlet part 122 is formed through the inside of the filter connection member coupling part 120. The raw water inlet part 122 extends in the height direction of the filter connection member coupling part 120, that is, in the up-down direction in the illustrated embodiment.

One side of the raw water inlet part 122 in the extension direction, that is, the upper side in the illustrated embodiment, is open to communicate with the inlet fitting 22. The other side of the raw water inlet part 122 in the extension direction, that is, the lower side in the illustrated embodiment, is open to communicate with the filter accommodation space 150.

In this case, the raw water inlet part 122 may be positioned to be spaced apart from the purified water outlet part 121. That is, in the illustrated embodiment, the raw water inlet part 122 may be positioned radially inside the purified water outlet part 121 and adjacent to the center of the filter connection member coupling part 120, thereby blocking direct communication with the purified water outlet part 121.

Accordingly, raw water flowing into the raw water inlet part 122 and purified water flowing out of the purified water outlet part 121 may not be mixed.

The raw water inlet part 122 may have any shape capable of communicating the inlet fitting 22 and the filter accommodation space 150. In the illustrated embodiment, the raw water inlet part 122 is formed as a cylindrical space having a circular cross-section and a height in the up-down direction.

The coupling protrusion 123 is a portion to which the filter accommodation body 110 is detachably coupled to the filter connection member 20. The coupling protrusion 123 is withdrawably accommodated in the openings 24a and 24b formed in the filter coupling part 24.

When the filter accommodation housing 100 is rotated while the coupling protrusion 123 is accommodated in the openings 24a and 24b, the filter accommodation housing 100 and the filter connection member 20 may be coupled to communicate with each other. In the above state, when the filter accommodation housing 100 is rotated in the opposite direction and the coupling protrusion 123 is positioned again in the openings 24a and 24b, the filter accommodation housing 100 may be moved to one side in the height direction, that is, downward in the illustrated embodiment, to be separated from the filter connection member 20.

The coupling protrusion 123 is continuous from the outer circumference of the filter connection member coupling part 120. The coupling protrusion 123 is formed to protrude from the outer circumference of the filter connection member coupling part 120 in the radial direction. The coupling protrusion 123 extends along the outer circumference of the filter connection member coupling part 120.

A plurality of coupling protrusions 123 may be formed. The plurality of coupling protrusions 123 may be withdrawably and rotatably accommodated in the plurality of openings 24a and 24b, respectively. In the illustrated embodiment, a pair of coupling protrusions 123 are provided, and are located on the left and right sides of the filter connection member coupling part 120, respectively. The pair of coupling protrusions 123 may be withdrawably accommodated in the first and second openings 24a and 24b, respectively.

The shape, number, and arrangement method of the coupling protrusions 123 may be changed according to the shape, number, and arrangement method of the openings 24a and 24b.

The filter accommodation base 130 is a part where the filter accommodation housing 100 is coupled to the filter support housing 300. The filter accommodation base 130 is accommodated in the filter support space 340 and is surrounded by the filter support body 310.

The filter accommodation base 130 may have any shape that may be accommodated in the filter support space 340 and surrounded by the filter support body 310. In the illustrated embodiment, the filter accommodation base 130 has a cylindrical shape having a circular cross-section and having a height in the up-down direction. In this case, since the filter accommodation space 150 is partially formed inside the filter accommodation base 130, it may be said that the cross-section of the filter accommodation base 130 is a ring shape.

The outer diameter of the cross-section of the filter accommodation base 130 may be formed to be equal to or less than the inner diameter of the cross-section of the filter support body 310. In addition, the inner diameter of the cross-section of the filter accommodation base 130 may be the same as the inner diameter of the cross-section of the filter accommodation body 110. Accordingly, the filter accommodation space 150 may be formed to have the same cross-sectional area in the height direction, that is, in the up-down direction in the illustrated embodiment.

The filter accommodation base 130 is disposed to face the filter accommodation body 110 with the filter accommodation plate 140 interposed therebetween. One side in the height direction of the filter accommodation base 130, that is, the upper side in the illustrated embodiment, is continuous with the filter accommodation plate 140. The other side in the height direction of the filter accommodation base 130, that is, the lower side in the illustrated embodiment, may be supported by the lower inner surface of the filter support body 310.

The filter accommodation space 150 is formed in the radially inside of the filter accommodation base 130. The filter accommodation thread 170 is formed on the outer circumference of the filter accommodation base 130.

The filter accommodation plate 140 is a part where the filter accommodation housing 100 is seated and supported on the filter support housing 300. The filter accommodation plate 140 is seated and supported on the filter support plate 330.

The filter accommodation plate 140 extends in the radial direction from the outer circumference of the filter accommodation body 110. The filter accommodation plate 140 extends along the outer circumference of the filter accommodation body 110. In the illustrated embodiment, the filter accommodation plate 140 is located at the lower end of the filter accommodation body 110 and is formed in a plate shape having a ring shape cross-section and having a thickness in the up-down direction.

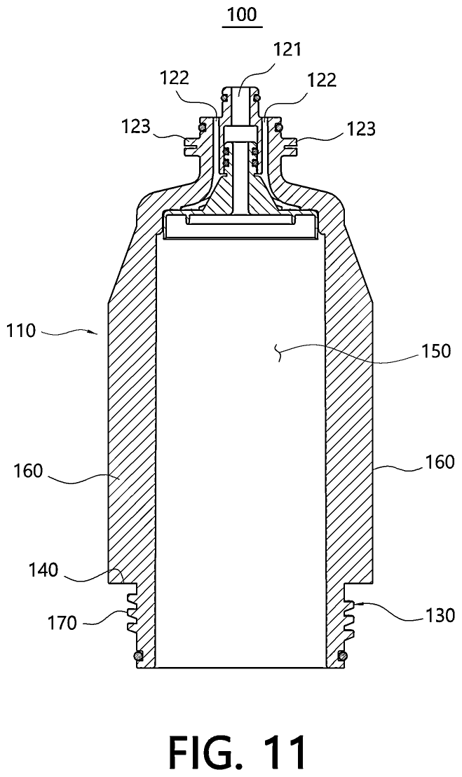

In an embodiment, the outer diameter of the cross-section of the filter accommodation plate 140 may be the same as the outer diameter of the cross-section of the anti-rolling rib 160 (see FIG. 11).

The filter accommodation plate 140 is positioned between the upper portion of the filter accommodation body 110 and the filter accommodation base 130 along the height direction of the filter accommodation housing 100, that is, along the up-down direction in the illustrated embodiment. Therefore, it will be understood that the filter accommodation plate 140 constitutes the lowest portion of the portion exposed to the outside after the filter accommodation housing 100 is coupled to the filter support housing 300.

In the illustrated embodiment, the filter accommodation plate 140 includes a filter accommodation identification protrusion 141.

The filter accommodation identification protrusion 141 is a part that allows a user to visually check whether the filter accommodation housing 100 has been rotated by a sufficient angle with respect to the filter support housing 300. The filter accommodation identification protrusion 141 is formed to protrude radially outward from the outer circumference of the filter accommodation plate 140.

In an embodiment, when the filter accommodation housing 100 is sufficiently rotated with respect to the filter support housing 300, the filter accommodation identification protrusion 141 may be positioned to overlap a filter support identification protrusion 331. In the above state, the filter accommodation housing 100 and the filter support housing 300 may be closely coupled to each other to seal the filter accommodation space 150 and the filter support space 340.

In addition, the filter accommodation identification protrusion 141 may restrict rolling movement of the filter accommodation housing 100, thereby limiting arbitrary movement of the filter accommodation housing 100. That is, the rolling of the filter accommodation body 110 formed in a cylindrical shape may be limited by the filter accommodation identification protrusion 141.

To this end, the end of the filter accommodation identification protrusion 141 may be located radially outward compared to the outer circumference of the filter accommodation body 110.

The filter accommodation identification protrusion 141 may have any shape capable of identifying the coupling angle between the filter accommodation housing 100 and the filter support housing 300 along with the filter support identification protrusion 331 and limiting any rolling of the filter accommodation housing 100. In the illustrated embodiment, the filter accommodation identification protrusion 141 is provided in a plate shape having an arc-shaped cross-section extending in the outer circumferential direction of the filter accommodation plate 140.

The filter accommodation space 150 is a space formed inside the filter accommodation housing 100. The filter accommodation space 150 at least partially accommodates the filter structure 200. In the illustrated embodiment, the filter accommodation space 150 accommodates the upper portion of the filter structure 200.

The filter accommodation space 150 communicates with the purified water outlet part 121 and the raw water inlet part 122 formed inside the filter connection member coupling part 120, respectively. The filter accommodation space 150 is fluidly connected to the outlet fitting 23 through the purified water outlet part 121, and is fluidly connected to the inlet fitting 22 through the raw water inlet part 122. The filter accommodation space 150 may be defined surrounded by the inner circumference of the filter accommodation body 110 and the inner circumference of the filter accommodation base 130.

The filter accommodation space 150 may have a shape corresponding to the shape of the filter structure 200. In the illustrated embodiment, the filter accommodation space 150 is formed as a cylindrical space having a circular cross-section and having a height in the up-down direction.

One side in the height direction of the filter accommodation space 150, that is, the upper side in the illustrated embodiment, is formed to be open to communicate with the purified water outlet part 121 and the raw water inlet part 122, respectively. The other side in the height direction of the filter accommodation space 150, that is, the lower side in the illustrated embodiment, is formed to be open to communicate with the filter support space 340. The radial direction of the filter accommodation space 150 is surrounded by the inner circumference of the filter accommodation body 110 and the inner circumference of the filter accommodation base 130, respectively.

The anti-rolling rib 160 is configured to prevent a situation in which the filter accommodation housing 100 is arbitrarily rolled along the outer circumferential direction.

The anti-rolling rib 160 is formed on the outer circumference of the filter accommodation body 110 formed in a cylindrical shape. The anti-rolling rib 160 may be formed to protrude further in the radial direction than the outer circumference of the filter accommodation body 110, thereby preventing a situation in which the filter accommodation body 110 is in direct contact with the ground.

Accordingly, even when the outer circumference of the filter accommodation body 110 is formed as the outer circumferential surface of the cylinder, arbitrary rolling of the filter accommodation housing 100 may be minimized.

The outer end of the anti-rolling rib 160 may be formed at the same position as the outer end in the radial direction of the filter accommodation plate 140. In other words, the distance from the filter accommodation body 110 to the outer end of the anti-rolling rib 160 may be the same as the outer diameter of the cross-section of the filter accommodation plate 140.

The anti-rolling rib 160 extends in the height direction of the filter accommodation body 110, that is, in the up-down direction in the illustrated embodiment. One side in the height direction of the anti-rolling rib 160, that is, the upper end in the illustrated embodiment, may be located lower than the upper end of the filter accommodation body 110.

Accordingly, the anti-rolling rib 160 is spaced apart from the filter connection member coupling part 120 in the height direction thereof, so that the coupling between the filter connection member coupling part 120 and the filter connection member 20 may not be hindered.

In this case, the one side in the height direction of the anti-rolling rib 160, that is, the upper end, may be formed to reduce the degree of protrusion in a direction toward the filter connection member coupling part 120, that is, toward the upper side. In other words, the upper end of the anti-rolling rib 160 extends obliquely along the height direction thereof.

The other side in the height direction of the anti-rolling rib 160, that is, the lower end in the illustrated embodiment, may be continuous with the filter accommodation plate 140. In an embodiment, the anti-rolling rib 160 may extend perpendicular to the filter accommodation plate 140.

A plurality of anti-rolling ribs 160 may be formed. The plurality of anti-rolling rib 160 may be disposed to be spaced apart from each other along the outer circumference of the filter accommodation body 110. In the illustrated embodiment, four anti-rolling ribs 160 are provided and are positioned on the front, rear, left and right sides of the filter accommodation body 110, respectively.

The filter accommodation thread 170 is screw-coupled to a filter support thread 360. When the filter accommodation housing 100 is rotated relative to the filter support housing 300, the filter accommodation thread 170 and the filter support thread 360 may be screw-coupled to or separated from each other.

The filter accommodation thread 170 is formed on the outer circumference of the filter accommodation base 130. The filter accommodation thread 170 may extend along the outer circumference of the filter accommodation base 130.

The position and shape of the filter accommodation thread 170 may be changed according to the position and shape of the filter support thread 360.

The filter structure 200 filters raw water provided from an external water source (not shown) to generate purified water. The filter structure 200 is accommodated in the filter accommodation housing 100 and the filter support housing 300, respectively, and is fluidly connected to the filter connection member 20.

The filter structure 200 is partially accommodated in the filter accommodation space 150 and the filter support space 340, respectively. In the illustrated embodiment, the lower side of the filter structure 200 is accommodated in the filter support space 340, and the remaining part of the filter structure 200 is accommodated in the filter accommodation space 150. The filter structure 200 accommodated in the filter accommodation space 150 and the filter support space 340 is surrounded by the filter accommodation body 110 and the filter support body 310 and is not exposed to the outside.

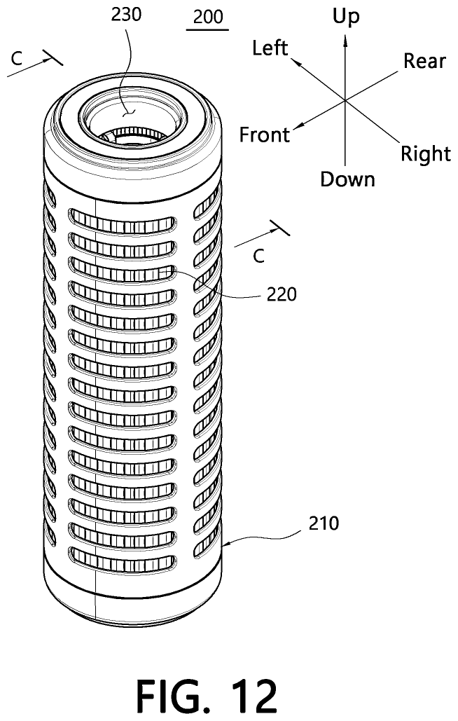

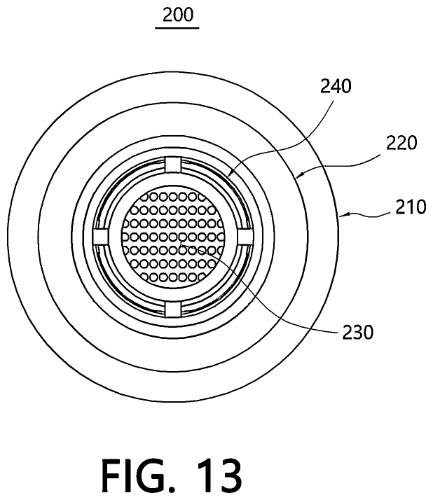

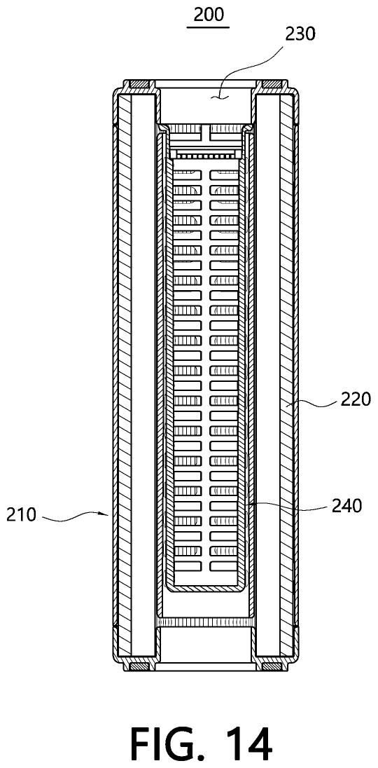

In the embodiments shown in FIGS. 12 to 15, the filter structure 200 includes a filter frame 210, a filter member 220, a filter hollow 230, a filter support member 240, and an additional filter member 250.

The filter frame 210 forms the outer shape of the filter structure 200. The filter frame 210 is a part in which the filter structure 200 is supported by the filter accommodation housing 100 and the filter support housing 300.

The filter frame 210 may have a shape corresponding to the shape of the filter accommodation space 150 and the filter support space 340. In the illustrated embodiment, the filter frame 210 has a cylindrical shape having a circular cross-section and having a height in the up-down direction.

In the illustrated embodiment, one side in the height direction of the filter frame 210, that is, the upper end in the illustrated embodiment, may support the upper inner surface of the filter accommodation body 110. The other side of the filter frame 210 in the height direction, that is, the lower end in the illustrated embodiment, may be supported by the lower inner surface of the filter support body 310.

A hollow is formed inside the filter frame 210. The hollow extends in the height direction of the filter frame 210, that is, in the up-down direction in the illustrated embodiment. Each end in the extension direction of the hollow may be open to communicate with the filter accommodation space 150 and the filter support space 340.

A plurality of through holes (reference numeral not indicated) communicating with the hollow are formed on the outer circumference of the filter frame 210. The through hole communicates the space of the filter frame 210 with the filter accommodation space 150 and the filter support space 340 along the radial direction. Raw water may flow toward the filter member 220 through the through hole.

The filter member 220 is accommodated in the space of the filter frame 210.

The filter member 220 substantially performs a role of filtering raw water to generate purified water. The filter member 220 may be provided in any form capable of generating purified water by filtering raw water. In an embodiment, the filter member 220 may be provided in the form of an R/O membrane filter.

The filter member 220 is accommodated in the space of the filter frame 210 and is supported by the filter frame 210. To this end, the filter member 220 may have a shape corresponding to the shape of the filter frame 210. In the illustrated embodiment, the filter member 220 has a cylindrical shape having a circular cross-section and having a height in the up-down direction.

The filter hollow 230 is formed inside the filter member 220.

The filter hollow 230 constitutes a part of a flow path through which generated purified water flows out while passing through the filter member 220. The filter hollow 230 is formed inside the filter member 220. The filter hollow 230 extends in the height direction of the filter member 220, that is, in the up-down direction in the illustrated embodiment.

Each end in the extension direction of the filter hollow 230 may be formed to be open to communicate with the purified water outlet part 121. The generated purified water may pass through the filter hollow 230 and the purified water outlet part 121 and flow out to the outlet fitting 23.

The filter hollow 230 may have any shape capable of constituting an outlet flow path for purified water. In the illustrated embodiment, the filter hollow 230 is formed as a cylindrical space having a circular cross-section and having a height in the up-down direction.

The filter support member 240 supports the filter member 220 located inside the filter frame 210 radially inside. The filter support member 240 is disposed to face the filter frame 210 with the filter member 220 interposed therebetween along the radial direction. The filter support member 240 may be positioned in the filter hollow 230.

Therefore, it will be understood that the radial outer side of the filter member 220 is supported by the filter frame 210 and the radial inner side of the filter member 220 is supported by the filter support member 240.

The filter support member 240 may have a shape corresponding to the shape of the filter member 220 or the filter hollow 230. In the illustrated embodiment, the filter support member 240 is formed to have a cylindrical outer shape having a circular cross-section and having a height in the up-down direction.

A hollow is formed inside the filter support member 240. The hollow may be in communication with the filter hollow 230 to form an outlet flow path of purified water. The hollow of the filter support member 240 may have a shape corresponding to the filter hollow 230. In the illustrated embodiment, the hollow of the filter support member 240 is formed as a cylindrical space having a circular cross-section and a height in the up-down direction.

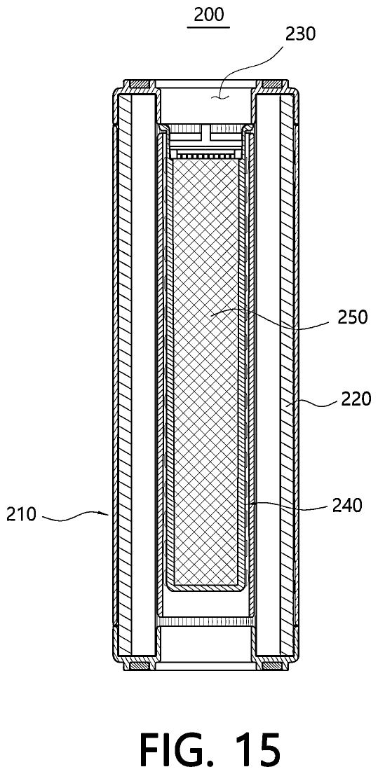

Meanwhile, referring again to FIG. 15, an additional filter member 250 may be further provided in the hollow of the filter support member 240. The additional filter member 250 may be configured to filter again the purified water generated while passing through the filter member 220. In an embodiment in which the additional filter member 250 is provided, raw water may be generated as purified water through at least two filtration processes. Accordingly, the water purification effect may be further improved.

The additional filter member 250 may have a shape corresponding to the shape of the filter hollow 230 or the hollow formed inside the filter support member 240. In the illustrated embodiment, the additional filter member 250 has a cylindrical shape having a circular cross-section and having a height in the up-down direction.

The additional filter member 250 may be provided in an arbitrary form capable of filtering again purified water having passed through the filter member 220. In an embodiment, the additional filter member 250 may be configured to generate purified water in a different manner from the filter member 220. In the above embodiment, the additional filter member 250 may be provided in the form of a hollow fiber membrane filter.

The filter support housing 300 forms the outer shape of the filter assembly 10 together with the filter accommodation housing 100. The filter support housing 300 accommodates the filter structure 200 together with the filter accommodation housing 100. The filter support housing 300 supports the accommodated filter structure 200 on one side in the height direction, that is, on the lower side in the illustrated embodiment. The filter support housing 300 is located on one side in the height direction of the filter accommodation housing 100, that is, on the lower side in the illustrated embodiment.

The filter support housing 300 is detachably coupled to the filter accommodation housing 100. As described above, the filter support housing 300 may be rotated relative to the filter accommodation housing 100 to be coupled to or separated from the filter accommodation housing 100. In the above embodiment, the filter support housing 300 may be screw-coupled to the filter accommodation housing 100.

The filter support housing 300 may be closely coupled to the filter accommodation housing 100. This is to seal the filter accommodation space 150 and the filter support space 340 to prevent arbitrary exposure of the filter structure 200 accommodated therein or arbitrary outflow of the introduced raw water or generated purified water.

Therefore, a large force is required to remove the filter support housing 300 and the filter accommodation housing 100. For easy coupling and separation between the filter support housing 300 and the filter accommodation housing 100, the filter assembly 10 according to an exemplary embodiment of the present invention includes a handle member 400 to be described later. This will be described later in detail.

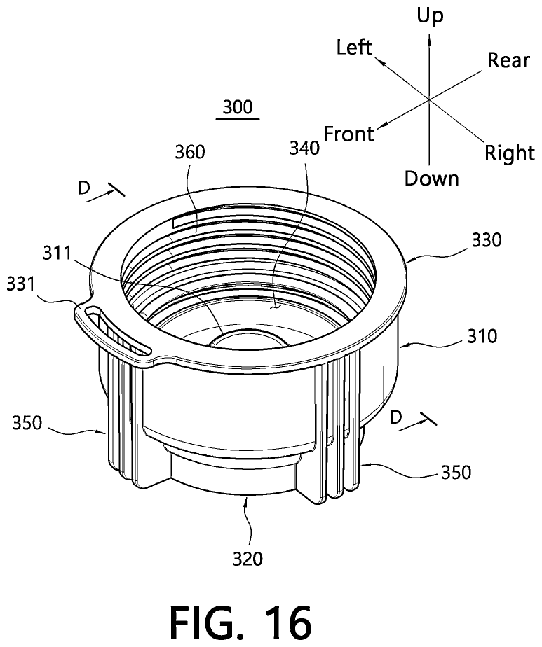

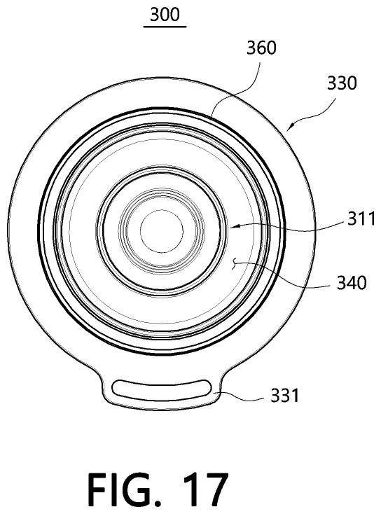

In the embodiments shown in FIGS. 16 to 18, the filter support housing 300 includes a filter support body 310, a filter support base 320, a filter support plate 330, a filter support space 340, a handle member coupling rib 350, and a filter support thread 360.

The filter support body 310 constitutes a part of the outer shape of the filter support housing 300. The filter support body 310 is coupled to other components of the filter support housing 300 to support them. In addition, the filter support space 340 is formed inside the filter support body 310, so that the filter structure 200 may be surrounded by the filter support body 310.

The filter support body 310 may have a shape corresponding to the shape of the filter support housing 300. In the illustrated embodiment, the filter support body 310 has a cylindrical shape having a circular cross-section and having a height in the up-down direction. In this case, the diameter of the cross-section of the filter support body 310 may be formed to be greater than or equal to the diameter of the cross-section of the filter support base 320.

One side in the height direction of the filter support body 310, that is, the lower end in the illustrated embodiment, is closed. The lower inner surface of the filter support body 310 may support the lower side of the filter structure 200.

The other side in the height direction of the filter support body 310, that is, the upper side in the illustrated embodiment, is open to communicate with the lower side of the filter accommodation space 150. The filter structure 200 may be accommodated in the filter support space 340 through the lower side of the filter support body 310.

The one side in the height direction of the filter support body 310, that is, the lower side in the illustrated embodiment, is continuous with the filter support base 320. The other side in the height direction of the filter support body 310, that is, the upper side in the illustrated embodiment, is continuous with the filter support plate 330.

The filter support space 340 is formed inside the filter support body 310. The handle member coupling rib 350 is partially positioned on the outer circumference of the filter support body 310. The filter support thread 360 is formed on the inner surface in the radial direction of the filter support body 310.

In the illustrated embodiment, the filter support body 310 includes a filter support column 311.

The filter support column 311 accommodates the filter structure 200 accommodated in the filter support space 340. The filter support column 311 extends upward from the lower inner surface of the filter support body 310. Alternatively, the filter support column 311 extends upward from the upper inner surface of the filter support base 320.

The filter support column 311 may be divided into a plurality of parts. Among the plurality of parts, one part positioned radially inside may be partially inserted into the filter hollow 230 (or the hollow formed inside the filter support member 240 accommodated in the filter hollow 230). Among the plurality of parts, another part radially positioned outside may support the lower end of any one of the filter frame 210, the filter member 220, and the filter support member 240.

In the above embodiment, the diameter of the cross-section of the one part may be formed to be less than or equal to the diameter of the cross-section of the filter hollow 230. In addition, the diameter of the cross-section of the another part may be formed to be greater than or equal to the diameter of the cross-section of the filter hollow 230.

The filter support base 320 constitutes another part of the outer shape of the filter support housing 300. The filter support base 320 is a part where the filter support housing 300 is coupled to the handle member 400.

The filter support base 320 is continuous with the filter support body 310. The filter support base 320 is disposed to face the filter support plate 330 with the filter support body 310 interposed therebetween. The filter support base 320 supports the filter support body 310 from the lower side.

The filter support base 320 may have an arbitrary shape that may be continuous with the filter support body 310 and support the filter support body 310. In the illustrated embodiment, the filter support base 320 has a cylindrical shape having a circular cross-section and extending in the up-down direction. In this case, the diameter of the cross-section of the filter support base 320 may be formed to be less than or equal to the diameter of the cross-section of the filter support body 310.

The filter support space 340 is formed inside the filter support base 320. The inner diameter of the cross-section of the filter support base 320 may be formed to be greater than or equal to the outer diameter of the cross-section of the filter accommodation base 130. In this case, the inner diameter of the cross-section of the filter support base 320 and the inner diameter of the cross-section of the filter support body 310 may be formed to be equal to each other.

Therefore, it will be understood that the filter support space 340 is formed to have the same cross-sectional area along its height direction, that is, the up-down direction.

The handle member coupling rib 350 is formed on the outer circumference of the filter support base 320. As will be described later, the handle member coupling rib 350 may be formed such that the lengths in the radial direction at a part thereof formed on the outer circumference of the filter support body 310 and at a part thereof formed on the outer circumference of the filter support base 320 are different from each other.

Accordingly, the handle member coupling rib 350 may be formed such that the distance from the center of the filter support space 340 to the radial outer end is constant along the height direction.

The filter support plate 330 is a part where the filter support housing 300 supports the filter accommodation housing 100. The filter support plate 330 supports the filter accommodation plate 140 on one side in the height direction, that is, on the lower side in the illustrated embodiment.

The filter support plate 330 extends in the radial direction from the outer circumference of the filter support body 310. The filter support plate 330 extends along the outer circumference of the filter support body 310. In the illustrated embodiment, the filter support plate 330 is located on one side in the height direction of the filter support body 310, that is, at the upper end and is formed in a plate shape having a ring shape cross-section and having a thickness in the up-down direction.

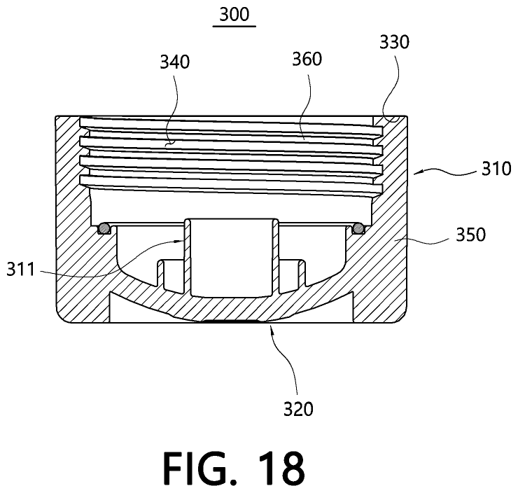

In an embodiment, the outer diameter of the cross-section of the filter support plate 330 may be the same as the distance from the center of the filter support space 340 to the radial outer end of the handle member coupling rib 350 (see FIG. 18).

The filter support plate 330 is located at the uppermost side along the height direction of the filter support housing 300, that is, the up-down direction in the illustrated embodiment.

In the illustrated embodiment, the filter support plate 330 includes a filter support identification protrusion 331.

The filter support identification protrusion 331 is a part that allows a user to visually check whether the filter support housing 300 has been rotated by a sufficient angle with respect to the filter accommodation housing 100. The filter support identification protrusion 331 is formed to protrude radially outward from the outer circumference of the filter support plate 330.

In an embodiment, when the filter support housing 300 is sufficiently rotated with respect to the filter accommodation housing 100, the filter support identification protrusion 331 may be positioned to overlap the filter accommodation identification protrusion 141. In the above state, the filter support housing 300 and the filter accommodation housing 100 may be closely coupled to each other to seal the filter accommodation space 340 and the filter support space 150.

In addition, the filter support identification protrusion 331 may restrict rolling movement of the filter support housing 300, thereby limiting arbitrary movement of the filter support housing 300. To this end, the end of the filter support identification protrusion 331 may be located radially outward compared to the outer circumference of the filter support body 310.

The filter support identification protrusion 331 may have any shape capable of identifying the coupling angle between the filter support housing 300 and the filter accommodation housing 100 along with the filter accommodation identification protrusion 141 and limiting any rolling of the filter support housing 300. In the illustrated embodiment, the filter support identification protrusion 331 is provided in a plate shape having an arc-shaped cross-section extending in the outer circumferential direction of the filter support plate 330.

The filter support space 340 is a space formed inside the filter support housing 300. The filter support space 340 at least partially accommodates the filter structure 200. In the illustrated embodiment, the filter support space 340 accommodates the lower portion of the filter structure 200.

The filter support space 340 may have a shape corresponding to the shape of the filter structure 200. In the illustrated embodiment, the filter support space 340 is formed as a cylindrical space having a circular cross-section and having a height in the up-down direction. The filter support column 311 may be positioned in the filter support space 340 to support the filter structure 200 accommodated in the filter support space 340.

One side in the height direction of the filter support space 340, that is, the upper side in the illustrated embodiment, is open to communicate with the filter accommodation space 150. The other side in the height direction of the filter support space 340, that is, the lower side in the illustrated embodiment, is closed to block communication with the outside.

The filter support space 340 may be defined surrounded by the inner circumference of the filter support body 310 and the inner circumference of the filter support base 320. The radial direction of the filter support space 340 is surrounded by the inner circumference of the filter support body 310 and the inner circumference of the filter support base 320, respectively. As described above, the filter support space 340 may be formed to have the same cross-sectional area along its height direction, that is, the up-down direction.

The handle member coupling rib 350 is a part where the filter support housing 300 is coupled to the handle member 400. The handle member coupling rib 350 is withdrawably accommodated in a rib accommodation groove 422 provided in the handle member 400.

The handle member coupling rib 350 is formed on the outer circumference of the filter support body 310 and the outer circumference of the filter support base 320. The handle member coupling rib 350 is formed to protrude in the radial direction from the outer circumference of the filter support body 310 and the outer circumference of the filter support base 320.

The handle member coupling rib 350 extends in the height direction of the filter support body 310 or the filter support base 320. In the illustrated embodiment, the handle member coupling rib 350 extends in the up-down direction, and the upper end thereof is continuous with the filter support plate 330. The lower end of the handle member coupling rib 350 may be positioned on the same plane as the lower end of the filter support base 320.

Therefore, it may be said that the handle member coupling rib 350 supports other components of the filter support housing 300 from the lower side along with the filter support base 320.

Meanwhile, the length at which the handle member coupling rib 350 protrudes in the radial direction may be formed to be different along the height direction thereof. As described above, the outer diameter of the cross-section of the filter support body 310 may be formed to be greater than or equal to the outer diameter of the cross-section of the filter support base 320.

Accordingly, among parts of the handle member coupling rib 350, the length at which a part thereof formed on the outer circumference of the filter support body 310 protrudes may be formed to be shorter than the length at which a part thereof formed on the outer circumference of the filter support base 320 protrudes.

Therefore, the handle member coupling rib 350 may maintain a constant distance from the center of the filter support space 340 along the height direction thereof.

The handle member coupling ribs 350 may be provided in a plurality of groups. The plurality of groups of handle member coupling ribs 350 may be disposed to be spaced apart from each other along the outer circumference of the filter support body 310 and the filter support base 320 and may be accommodated in the plurality of rib accommodation grooves 422, respectively. In the illustrated embodiment, the handle member coupling ribs 350 are provided in four groups and are disposed to be spaced apart from each other along the outer circumference of the filter support body 310 and the filter support base 320.

In this case, in a state in which the filter accommodation housing 100 and the filter support housing 300 are closely coupled to each other, the plurality of groups of handle member coupling ribs 350 may be disposed to overlap the plurality of anti-rolling ribs 160 in the height direction thereof, that is, in the up-down direction in the illustrated embodiment.

In addition, each group of handle member coupling ribs 350 may be configured to include a plurality of handle member coupling ribs 350. The plurality of handle member coupling ribs 350 constituting any one group may be disposed to be spaced apart from each other along the outer circumference of the filter support body 310 or the filter support base 320 at a predetermined angle with respect to the center of the filter support body 310 or the filter support base 320.

In the illustrated embodiment, three handle member coupling ribs 350 constitute one group. The three handle member coupling ribs 350 are disposed to be spaced apart from each other along the outer circumference of the filter support body 310 or the filter support base 320.

The shape, number, and arrangement method of the handle member coupling ribs 350 may be changed according to the shape, number, and arrangement method of the rib accommodation grooves 422.

The filter support thread 360 is screw-coupled to the filter accommodation thread 170. When the filter support housing 300 is rotated relative to the filter accommodation housing 100, the filter support thread 360 and the filter accommodation thread 170 may be screw-coupled to or separated from each other.

The filter support thread 360 is formed on the inner circumference of the filter support body 310. The filter support thread 360 may extend along the inner circumference of the filter support body 310. The position and shape of the filter support thread 360 may be changed according to the position and shape of the filter accommodation thread 170.

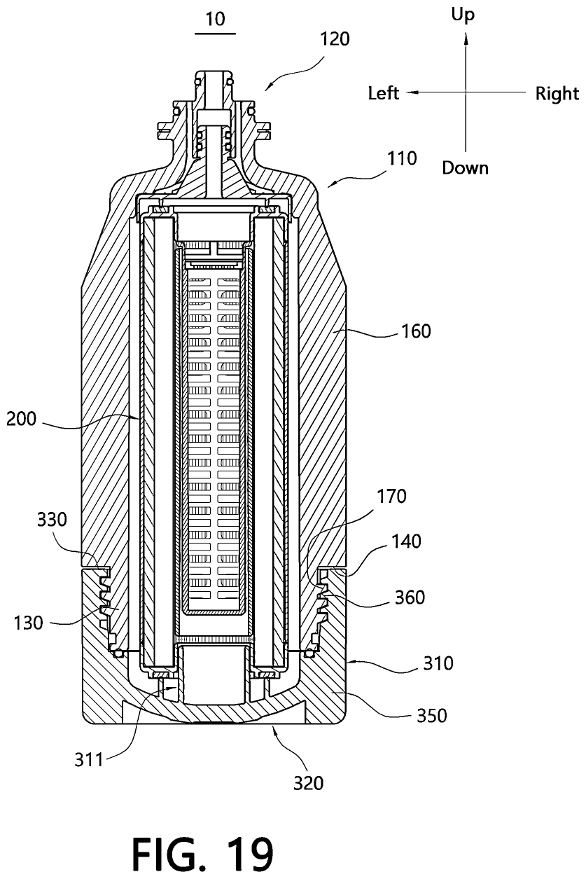

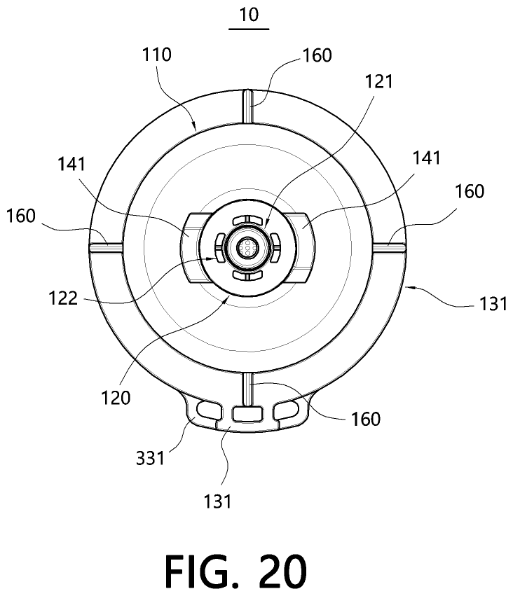

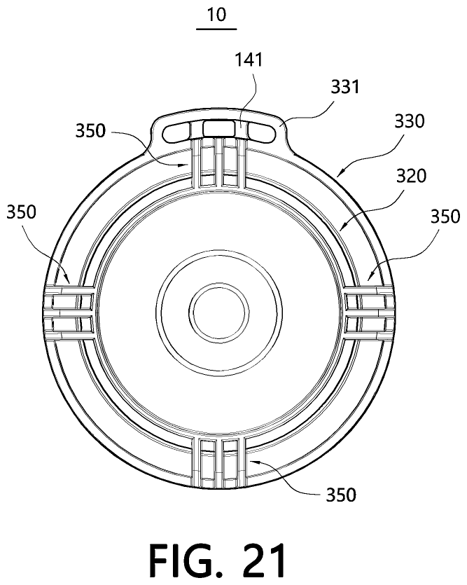

Referring to FIGS. 19 to 21, a state in which the components of the filter assembly 10 according to an exemplary embodiment of the present invention are coupled to each other is illustrated as an example.

In the illustrated embodiment, the filter accommodation housing 100 and the filter support housing 300 are coupled to each other while accommodating the filter structure 200. The coupling may be formed by screwing the filter accommodation thread 170 and the filter support thread 360 to each other.

In the above state, the filter accommodation plate 140 and the filter support plate 330 are closely coupled to each other. Accordingly, the filter accommodation space 150 and the filter support space 340 are sealed, so that the filter structure 200 accommodated therein is not arbitrarily exposed to the outside.

In addition, the anti-rolling rib 160 and the handle member coupling rib 350 are arranged to overlap each other along the up-down direction, and the filter accommodation identification protrusion 141 and the filter support identification protrusion 331 are also arranged to overlap along the up-down direction.

In the above state, raw water sequentially flows through the inlet fitting 22 and the raw water inlet part 122 into the filter accommodation space 150 and the filter support space 340 communicating therewith. In this case, the raw water is introduced along the radial outside of the filter structure 200, passes through the filter member 220, and is generated as purified water. The generated purified water may sequentially pass through the filter hollow 230 and the purified water outlet part 121 and flow out to the outlet fitting 23.

Although not shown, the filter structure 200 is further provided with an additional filter member 250 to filter again the purified water generated while passing through the filter member 220, as described above.

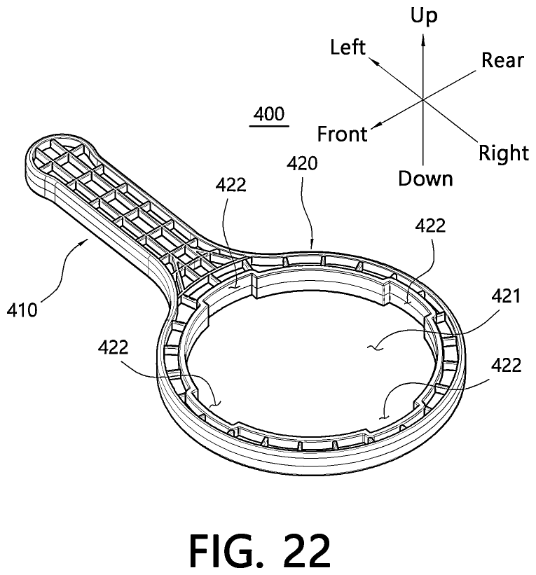

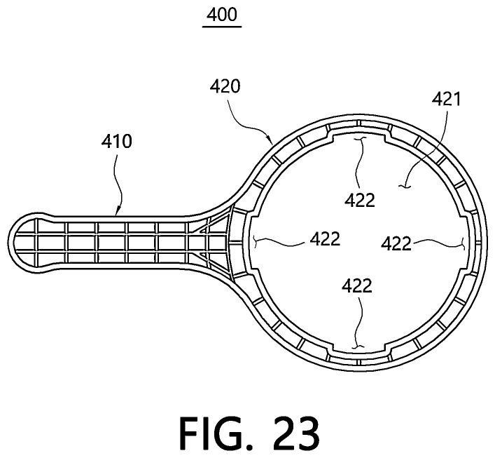

Referring to FIGS. 22 to 23, a handle member 400 according to an exemplary embodiment of the present invention is shown. As described above, the handle member 400 may be provided as a component of the filter assembly 10, or may be provided separately from the filter assembly 10.

The handle member 400 may be detachably coupled to the filter support housing 300. The handle member 400 may rotate the filter support housing 300. Accordingly, the filter support housing 300 is rotated relative to the filter accommodation housing 100, so that the filter support housing 300 and the filter accommodation housing 100 may be coupled to or separated from each other.

The handle member 400 may be coupled to the filter support housing 300 through one side in the height direction of the filter support housing 300, that is, the lower side.

The handle member 400 may be formed of a lightweight yet highly rigid material. This is to prevent damage due to the applied external force while being easy to carry and operate. In an embodiment, the handle member 400 may be formed of a synthetic resin material such as reinforced plastic.

In the illustrated embodiment, the handle member 400 includes a gripping extension 410 and a filter housing coupling part 420.

The gripping extension 410 is a part where the handle member 400 is gripped by a user or a tool or the like. The gripping extension 410 is formed to extend in one direction, that is, in the left-right direction in the illustrated embodiment.

The gripping extension 410 is continuous with the filter housing coupling part 420. The gripping extension 410 may be rotated together with the filter housing coupling part 420. The external force applied to the gripping extension 410 may also be applied to the rotation of the filter housing coupling part 420.

It is preferable that the gripping extension 410 is formed long enough to rotate the filter housing coupling part 420 and the filter support housing 300 coupled thereto even with a small force. That is, as is known, the torque may be defined as the applied force (F) and the length (r) in a direction perpendicular thereto, and the length of the gripping extension 410 corresponds to (r) above.

Therefore, as the length of the gripping extension 410 increases, the size of the force (F) that must be applied to rotate the filter support housing 300 coupled to the filter housing coupling part 420 may decrease. However, if the length of the gripping extension 410 is excessively increased, there is a risk that the gripping extension 410 is damaged by the applied force (F).

Therefore, it is preferable that the length of the gripping extension 410 is determined in consideration of the reduction of the force (F) to be applied and the rigidity of the gripping extension 410.

The filter housing coupling part 420 is a part in which the gripping extension 410 is coupled to the filter support housing 300. The filter housing coupling part 420 may be continuous with the gripping extension 410 to receive an external force applied to the gripping extension 410. The filter housing coupling part 420 may transmit the transmitted external force to the filter support housing 300.

The filter housing coupling part 420 may have any shape that may be detachably coupled to the filter support housing 300. In the illustrated embodiment, the filter housing coupling part 420 has a disk shape having a circular cross-section and having a space (i.e., a filter housing accommodation space 421 to be described later) formed therein. One side of the outer circumference of the filter housing coupling part 420, that is, the left side in the illustrated embodiment, is continuous with the gripping extension 410.

In the illustrated embodiment, the filter housing coupling part 420 includes a filter housing accommodation space 421 and a rib accommodation groove 422.

The filter housing accommodation space 421 is a space in which the filter support housing 300 is withdrawably accommodated. The filter housing accommodation space 421 is located inside the filter housing coupling part 420. The filter housing accommodation space 421 may have a shape corresponding to the shape of the filter housing coupling part 420, the filter support body 310, or the filter support base 320.

In the illustrated embodiment, the filter housing accommodation space 421 has a cylindrical shape having a circular cross-section and having a thickness in the up-down direction. Each side in the height direction of the filter housing accommodation space 421, that is, the upper side and the lower side in the illustrated embodiment, are formed to be open, respectively, so that the filter support body 310 and the filter support base 320 may be withdrawably accommodated. The radial direction of the filter housing accommodation space 421 may be defined surrounded by the inner circumference of the filter housing coupling part 420.

In the above embodiment, the diameter of the cross-section of the filter housing accommodation space 421 may be greater than or equal to the outer diameter of the cross-section of the filter support body 310. In an embodiment, the diameter of the cross-section of the filter housing accommodation space 421 may be the same as the outer diameter of the cross-section of the filter support body 310. Therefore, it will be understood that the diameter of the cross-section of the filter housing accommodation space 421 is formed to be greater than or equal to the diameter of the cross-section of the filter support base 320.

The rib accommodation groove 422 is a space for withdrawably accommodating the handle member coupling rib 350 formed in the filter support housing 300. As the handle member coupling rib 350 is accommodated in the rib accommodation groove 422, the rotation of the handle member 400 may be completely transmitted to the filter support housing 300.

That is, the handle member 400 is prevented from spinning with no traction, so that the filter support housing 300 may be rotated relative to the filter accommodation housing 100 by an applied external force.

The rib accommodation groove 422 is formed to be recessed in the inner circumference of the filter housing coupling part 420 surrounding the filter housing accommodation space 421. The rib accommodation groove 422 is partially surrounded by the inner circumference of the filter housing coupling part 420.

Therefore, the distance from the center of the filter housing coupling part 420 to the inner circumference surrounding the rib accommodation groove 422 may be formed to be longer than the distance from the center of the filter housing coupling part 420 to the inner circumference surrounding the filter housing accommodation space 421.

The rib accommodation groove 422 may have a shape corresponding to the shape of the handle member coupling rib 350. In the illustrated embodiment, the rib accommodation groove 422 extends along the inner circumference of the filter housing coupling part 420 and is formed to be recessed radially outward of the filter housing coupling part 420.

Accordingly, the rib accommodation groove 422 is surrounded by a part where the rib accommodation groove 422 is not formed in the inner circumferential direction of the filter housing coupling part 420. The part may transmit an external force applied to the handle member coupling rib 350 accommodated in the rib accommodation groove 422.

A plurality of rib accommodation grooves 422 may be formed. The plurality of rib accommodation grooves 422 may be respectively coupled to the handle member coupling rib 350 at different positions. In the illustrated embodiment, a total of four rib accommodation grooves 422 are formed and are disposed to be spaced apart from each other along the inner circumference of the filter housing coupling part 420.

As described above, in an embodiment in which the anti-rolling rib 160 and the handle member coupling rib 350 are arranged to be overlapped in the up-down direction, the rib accommodation groove 422 may also be arranged to be overlapped with the anti-rolling rib 160 or the handle member coupling rib 350.

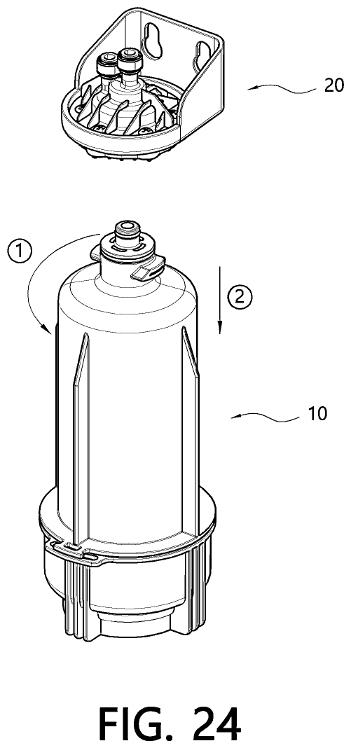

Referring to FIGS. 24 to 26, a process in which the filter assembly 10 according to an exemplary embodiment of the present invention is separated from the filter connection member 20 and the filter structure 200 provided in the filter assembly 10 is separated is illustrated as an example.

Referring to FIG. 24, first, a process of separating the filter connection member 20 and the filter assembly 10 is illustrated.

When the filter assembly 10 is rotated and the coupling protrusion 123 is accommodated in the first and second openings 24a and 24b (\textcircled{1}), the filter assembly 10 may be moved downward and separated from the filter connection member 20 (\textcircled{2}).

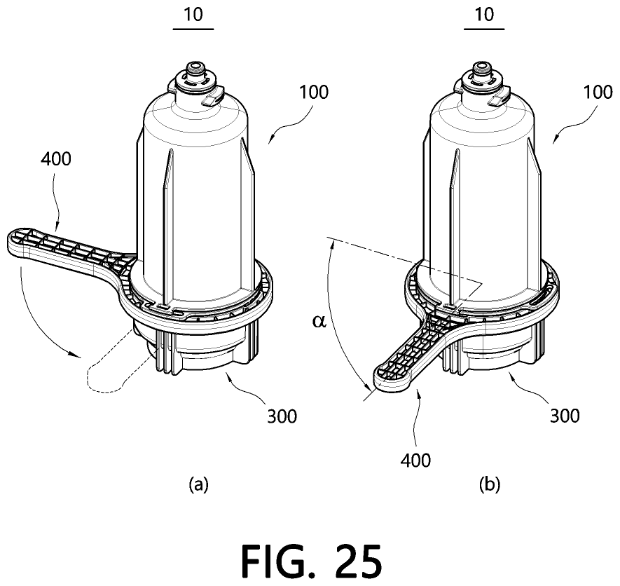

Referring to FIG. 25, a process in which the handle member 400 is coupled to the filter support housing 300 of the filter assembly 10 and rotated is illustrated.

When a rotational force is applied to the gripping extension 410 after the filter support body 310 is accommodated in the filter housing accommodation space 421, the filter support body 310 coupled to the handle member 400 may be rotated by a predetermined angle a. In an embodiment, the predetermined angle a may be a right angle. Accordingly, the close coupling state between the filter support housing 300 and the filter accommodation housing 100 may be released.

Thereafter, the size of the external force to be applied to relatively rotate the filter support housing 300 and the filter accommodation housing 100 is reduced. Accordingly, after the handle member 400 is separated from the filter support housing 300, the user may separate the filter support housing 300 and the filter accommodation housing 100 by manually gripping the filter support housing 300 and the filter accommodation housing 100 and then applying an external force.

Of course, even when external force is further applied to the handle member 400 while the handle member 400 is coupled to the filter support housing 300, the filter support housing 300 and the filter accommodation housing 100 may be rotated relatively and separated.

In this case, the handle member coupling rib 350 may be accommodated in the rib accommodation groove 422, thereby preventing spinning with no traction of the handle member 400. In addition, the filter accommodation plate 140 or the filter support plate 330 can prevent the handle member 400 from rising to the filter accommodation housing 100.

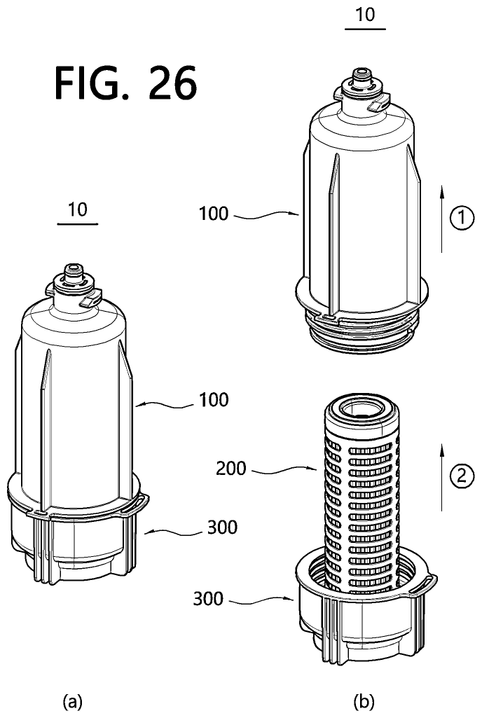

Referring to FIG. 26, a separation process of the filter assembly 10 is illustrated after the coupling between the filter accommodation thread 170 and the filter support thread 360 is released.

When the filter accommodation housing 100 is moved upward while the filter support housing 300 is seated, the filter structure 200 may be exposed to the outside (\textcircled{1}). Thereafter, after separating the filter structure 200 from the filter support housing 300, a maintenance process for the filter structure 200 may be performed (\textcircled{2}).

Although not shown, it will be understood that the above-described process may be performed in reverse so that the filter accommodation housing 100, the filter structure 200, and the filter support housing 300 may be coupled, and the filter assembly 10 may be coupled to the filter connection member 20.

Although exemplary embodiments of the present invention have been described, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the scope of the present invention.

What is claimed is:

1. A filter assembly, comprising:
a first housing configured to be connected to the outside to receive raw water and transmit purified water to the outside;
a second housing configured to be screw-coupled to the first housing and be connected to the outside; and
a filter structure partially accommodated in each of the first and the second housing, and configured to filter the raw water to generate the purified water,
wherein the second housing comprises:
a first body having a height in a direction and having a first space for at least partially accommodating the filter structure; and
a first rib protruding in a radial direction from an outer circumference of the first body.

2. The filter assembly of claim 1, further comprising:
a handle configured to be coupled to the second housing and rotate together with the second housing by an external force,
wherein the close coupling state between the first housing and the second housing is released when the handle is rotated by a preset angle.

3. The filter assembly of claim 2, wherein a first part of the handle is configured to surround the outer circumference of the first body, and a second part of the handle is configured to surround the first rib.

4. The filter assembly of claim 3, wherein the first rib is configured to have a height in the direction, a width in the radial direction, and a thickness in an outer circumferential direction of the first body.

5. The filter assembly of claim 3, wherein the handle comprises:
a gripping extension configured to extend in the radial direction of the second housing; and
a coupler configured to be connected to the gripping extension and surround the first body in the radial direction.

6. The filter assembly of claim 5, wherein the coupler comprises:
a second space formed through therein to accommodate the first body; and
a groove in a recessed inner circumference surrounding the second space to accommodate the first rib.

7. The filter assembly of claim 6,
wherein the first ribs are provided as a plurality of groups, and the plurality of groups of the first ribs are spaced apart from each other at a predetermined angle along the outer circumference of first body, and
wherein the grooves are provided as a plurality of groups, and the plurality of the grooves are spaced apart from each other at the predetermined angle along the inner circumference of the coupler.

8. The filter assembly of claim 7, wherein the plurality of the first ribs spaced apart from each other along the outer circumference of the first body constitute the group.

9. The filter assembly of claim 2, further comprising:
a first base positioned on one side in the height direction of the first body and configured to have a smaller cross-sectional area than the first body,
wherein the first rib is configured to extend between the other end in the height direction of the first body and a lower end of the first base.

10. The filter assembly of claim 9, wherein among each end of the first rib, a width of one end positioned adjacent to the other end in the height direction of the first body is shorter than a width of the other end positioned adjacent to the lower end of the first base.

11. The filter assembly of claim 1, further comprising:
a second body having a height in the direction and in which a third space is formed to at least partially accommodate the filter structure;
a second base on one side in the height direction of the second body and coupled to the second housing; and
an second rib protruding in the radial direction from the outer circumference of the second body.

12. The filter assembly of claim 11, wherein the second rib has a height in the direction, a thickness in the radial direction, and a width in the outer circumferential direction of the second body.

13. The filter assembly of claim 12, wherein a plurality of the second ribs are provided, and the plurality of the second ribs are to be spaced apart from each other along the outer circumference of the second body at a predetermined angle.

14. The filter assembly of claim 1,
wherein the second housing comprises:
the first body having the height in the direction and having the first space for at least partially accommodating the filter structure; and
a first plate positioned on one side in the height direction of the first body and configured to protrude further in the radial direction than the first body, and
wherein the first housing comprises:
the second base configured to constitute one side in the height direction and be accommodated in the first body; and
a second plate configured to constitute the other side in the height direction of the second base, be seated on the first plate, and protrude further in the radial direction than the second base.

15. The filter assembly of claim 14,
wherein the first plate comprises:
a first protrusion configured to protrude radially from the outer circumference thereof, and
wherein the second plate comprises:
a second protrusion configured to protrude radially from the outer circumference thereof.

16. The filter assembly of claim 1,
wherein the filter structure comprises:
a frame configured to extend in the direction and communicate with internal spaces of the first housing and the second housing, respectively;
a first filter accommodated inside the frame and configured to filter the raw water flowing in the radial direction to generate the purified water; and
a hollow formed through the filter in the direction to constitute an outlet flow path of the purified water.

17. The filter assembly of claim 16,
wherein the filter structure further comprises:
a second filter inserted into the hollow, and configured to filter the purified water filtered while passing through the first filter.
